(19) United States
(12) Patent Application Publication
(10) Pub. No.: US 2025/0039590 A1
(43) Pub. Date: Jan. 30, 2025

(54) Capacitive On-Head Detection Using a Magnetically-Sensitive Section

(71) Applicant: Google LLC, Mountain View, CA (US)

(72) Inventors: Yao Ding, San Jose, CA (US); Tauseef Muzaffar, Santa Clara, CA (US)

(73) Assignee: Google LLC, Mountain View, CA (US)

(21) Appl. No.: 18/768,837

(22) Filed: Jul. 10, 2024

Related U.S. Application Data
(63) Continuation of application No. PCT/US2023/070956, filed on Jul. 25, 2023.

(51) Int. Cl. H04R 1/10

(52) U.S. Cl. CPC H04R 1/1016; H04R 1/1041

(57) ABSTRACT

This document describes systems and techniques for determining whether an earbud is removed from within an ear of a user. The systems and techniques employ an earbud including a housing having a distal end and a proximal end. The distal end includes a magnetically-sensitive section, the distal end of the housing being configured to be magnetically attracted to a charging receptacle and insertable within an ear of a user. On-head detection (OHD) logic is electrically coupled to the magnetically-sensitive section at the distal end, the OHD logic configured to determine based on a distal-end capacitance measured using the magnetically-sensitive section whether the distal end of the housing is within the ear of the user.

### CROSS-REFERENCE TO RELATED APPLICATION(S)

This application is a continuation of and claims priority to International Patent Application Serial No. PCT/US2023/070956, filed on Jul. 25, 2023, the disclosure of which is incorporated by reference herein in its entirety.

### BACKGROUND

People commonly use wireless earbuds to make phone or video calls or to listen to music or other audio. These earbuds often include one or more controls to aid in their use, such as to end a call or to pause a stream of audio. Some earbuds also include circuitry that may detect when an earbud is removed from an ear and, in response, automatically stop the stream of audio. Stopping the stream of audio when the earbud is removed is desirable to prevent the user from missing a portion of the audio, to prevent unwanted sound being generated by the removed earbud, and/or to prevent waste of battery power from continuing to generate audio. An earbud, however, is by nature a very compact device, which limits its capabilities and capacity to incorporate components to stop streams of audio.

### SUMMARY

This document describes systems and techniques for determining whether an earbud is removed from within an ear of a user. The systems and techniques employ an earbud including a housing having a distal end and a proximal end. The distal end includes a magnetically-sensitive section, the distal end of the housing being configured to be magnetically attracted to a charging receptacle and insertable within an ear of a user. On-head detection (OHD) logic is electrically coupled to the magnetically-sensitive section at the distal end, the OHD logic configured to determine based on a distal-end capacitance measured using the magnetically-sensitive section whether the distal end of the housing is within the ear of the user.

For example, an earbud is described in which the OHD logic monitors a distal-end capacitance at the magnetically-sensitive section to determine whether the magnetically-sensitive section is removed from the ear surface of the user solely based on the distal-end capacitance. Alternatively, the OHD logic also may monitor a proximal-end capacitance at a touch-sensitive user input component at a proximal end of the housing to determine whether the proximal end of the earbud-which faces away from the ear when the earbud is inserted within the ear—is in contact with a body indicating that the earbud is removed from within the ear. The OHD logic also may monitor an additional OHD sensor that detects a value, such as an infrared (IR) sensor that detects IR energy emitted by IR proximity sensor that is being reflected by the ear, to determine whether the earbud is removed from within the ear. In various implementations, the OHD logic may first determine whether the earbud is removed from the ear by using one of the distal-end capacitance, the proximal-end capacitance, or the additional value, then use one or more of the other values to confirm whether the earbud is removed from the ear. Alternatively, the OHD logic may use a combination of all of the distal-end capacitance, the proximal-end capacitance, and the additional value in determining whether the earbud is inserted into or is removed from within the ear.

This Summary is provided to introduce systems and techniques for using capacitances monitored at a magnetically-sensitive section and/or a touch-sensitive user input component and/or the additional value detected by the additional OHD sensor to determine whether an earbud is removed from within an ear, as further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques for using capacitances monitored at a magnetically-sensitive section and/or a touch-sensitive user input component or an additional value detected by an additional OHD sensor to determine whether the earbud is removed from within an ear are described in this document with reference to the following drawings. The same numbers are used throughout the drawings to reference like features and components:

FIG. 1 is a block diagram in cutaway form of an earbud including on-head detection (OHD) logic to monitor capacitance at a magnetically-sensitive section within a distal end of a housing of the earbud;

FIG. 2 is a cutaway view of a charging case configured to magnetically secure the earbuds of FIG. 1 into charging receptacles of the charging case;

FIG. 3 is a schematic diagram of the OHD logic of FIG. 1 configured to measure capacitances and another value to determine if the earbud of FIG. 1 is removed from within an ear;

FIGS. 4A-4C, 5A-5D, and 6A-6D are perspective views of implementations of the earbud of FIG. 1 configured to monitor capacitances and/or another value to determine if the earbud is inserted within an ear or is located on a surface or in a hand of a user;

FIG. 7 is a block diagram of an earbud including a programmable processor to perform the function of implementations of the apparatus of FIG. 1; and

FIGS. 8-10 are flow diagram of example methods of using implementations of the earbuds of FIGS. 1 and 7 to determine whether the earbud has been removed from within the ear.

### DETAILED DESCRIPTION

### Overview

Implementations disclosed use a magnetically-sensitive section within a distal end of a housing of an earbud to determine if the earbud is inserted within an ear of the user. The magnetically-sensitive section may be configured to magnetically attract the earbud to a charging receptacle to secure the earbud within the charging receptacle included in a charging case. The magnetically-sensitive section is also electrically coupled to on-head detection (OHD) logic to use the magnetically-sensitive section for monitoring a capacitance at the distal end of the housing (the “distal-end capacitance”). The distal-end capacitance may change based on whether the distal end of the housing is inserted into the ear and, thus, is in proximity with the ear surface to cause the magnetically-sensitive section to be capacitively coupled with the ear surface. Generally, a human body may be characterized as an electrode of a capacitor coupled to ground. Thus, when the earbud is inserted into the ear and is in proximity with the ear surface, the distal-end capacitance increases; by contrast, when the earbud is removed from the ear and no longer is in proximity to the ear surface, the distal-end capacitance decreases. Thus, the change in the distal-end capacitance can be used by the OHD logic to determine whether the earbud has been removed from the ear of the user.

Because the OHD logic makes use of the magnetically-sensitive section as an electrode layer to monitor the distal-end capacitance, the OHD logic can monitor the distal-end capacitance without adding an additional electrode layer within the earbud. An earbud necessarily is a compact device and offers little room to add components, thus, using the magnetically-sensitive section as an electrode layer avoids having to try to fit an additional component within the earbud. Moreover, when the magnetically-sensitive section spans a substantial portion the distal end of the housing, it provides an electrode layer with a sizable surface to be able to render an accurate measurement of the distal-end capacitance.

In addition, a proximal end of the housing may support a touch-sensitive user input component that a user may employ to control operation of the earbud, such as to answer or end a call, play or pause audio, increase or decrease volume, engage or disengage active noise cancellation (ANC) features, etc. The touch-sensitive user input component may also be used by the OHD logic as an electrode layer to monitor a capacitance at the proximal end of the housing (the “proximal-end capacitance”). When the touch-sensitive user input component includes multiple segments, the segments may be electrically joined together to form a larger, unified electrode to measure the proximal-end capacitance. The proximal-end capacitance may increase when the touch-sensitive user input component is in proximity to a body, such as when the earbud is held within a user's hand or placed in a pocket in proximity to a user's body. In such cases where the earbud is in proximity to the body, the distal-end capacitance also may be high, falsely indicating that the earbud is inserted within the user's ear; however, the proximal-end capacitance being high indicates that the earbud may not actually be inserted within the user's ear. Thus, the OHD logic may use both the distal-end capacitance and the proximal-end capacitance to determine whether an earbud is inserted into the ear of the user. The OHD logic may be configured to first monitor the distal-end capacitance to determine whether the earbud is inserted into the ear, then use the proximal-end capacitance to confirm whether the earbud is inserted into the user's ear or vice versa.

An additional OHD sensor also may be included in the housing where the additional OHD sensor monitors an additional value indicative of whether the earbud is inserted within the ear. For example, the additional OHD sensor may include an infrared (IR) sensor that monitors heat energy, such as the body heat of the ear that may be detected when the earbud is inserted into the ear. The additional value may be provided to the OHD logic to determine, in combination with the distal-end capacitance and/or the proximal-end capacitance, whether the earbud is removed from within the user's ear. Thus, for example, if the earbud is removed from within the user's ear, but is placed in a user's pocket or other warm location falsely indicative of the body heat present within the ear, the distal-end capacitance and/or the proximal-end capacitance may be used to determine whether the earbud is removed from within the ear.

This document describes systems and techniques for determining whether an earbud is removed from within an ear of a user. The systems and techniques employ an earbud including a housing having a distal end and a proximal end. The distal end includes a magnetically-sensitive section, the distal end of the housing being configured to be magnetically attracted to a charging receptacle and insertable within an ear of a user. On-head detection (OHD) logic is electrically coupled to the magnetically-sensitive section at the distal end, the OHD logic configured to determine based on a distal-end capacitance measured using the magnetically-sensitive section whether the distal end of the housing is within the ear of the user.

### Example Systems

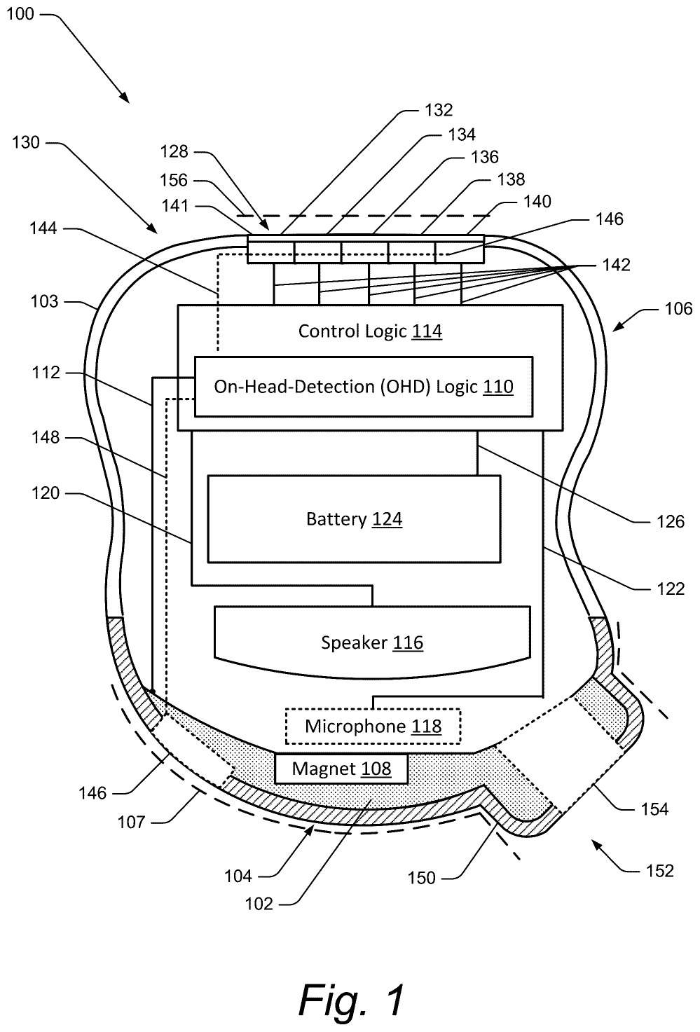

FIG. 1 illustrates an earbud 100 that includes a magnetically-sensitive section 102 within a distal end 104 of a housing 106 of the earbud 100. In various implementations, the magnetically-sensitive section 102 may be formed to substantially span a length and width of a surface of the distal end 102 of the housing 106. By spanning at least a substantial portion of the distal end 104 of the housing 106, the magnetically-sensitive section 102 forms a relatively large electrode or plate (or as large as the earbud 100 can accommodate) to measure capacitance at the distal end 102 of the earbud 100.

As is understood by those ordinarily skilled in the art, capacitance is, in part, a function of the area of the electrodes or plates at which the capacitance is measured. The magnetically-sensitive section 102 forms one electrode layer or plate of a capacitor with an ear surface 107 (represented in dashed lines in FIG. 1) and the remainder of the body serving as the rest of the capacitor. Electrically, the human body may be characterized as a dielectric or a capacitor coupled to ground. Capacitance is also inversely proportional to distance between the plates of capacitor. With the distal end 104 (and the magnetically-sensitive section 104 received therein) disposed in contact with or in proximity to the ear surface 107, the distance between the two opposing electrode layers or plates is small. Thus, in presenting a relatively large plate at a short distance from the ear surface 107, the magnetically-sensitive section 102 is well-positioned to measure capacitance indicating proximity to the ear surface 107 that is indicative of whether the earbud 100 is inserted within the ear.

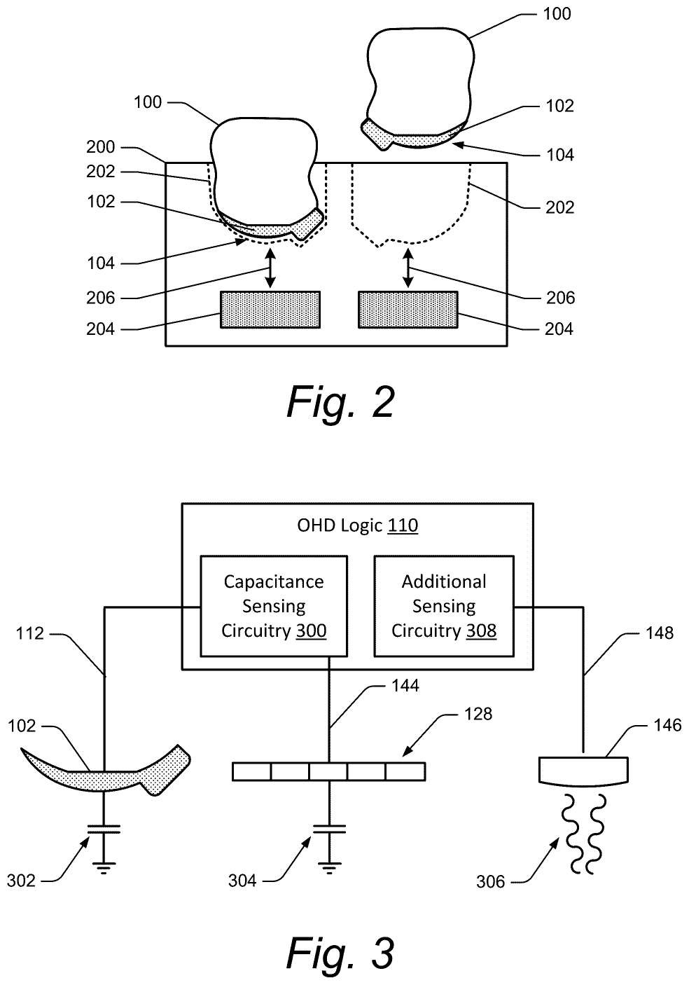

The magnetically-sensitive section 102 of FIG. 1, for example, may be formed using metal injection molding (MIM) in which a metal powder is mixed with a resin, plastic, or other binding material that hardens to form a solid part. With the metal powder incorporated within the binding material, the part formed includes properties of the included metal, including conductivity and magnetic properties. The metal incorporated in the magnetically-sensitive section 102 may include a ferrous metal, in order to provide the magnetically-sensitive section 102 with magnetic properties to facilitate magnetically securing the earbud 100 within a charging receptacle, as further described below with reference to FIG. 2. The metal incorporated in the magnetically-sensitive section 102 also provides conductivity to enable the magnetically-sensitive section 102 to be used as an electrode to monitor a capacitance at the distal end 104 (a “distal-end capacitance”) of the housing 106 of the earbud 100, as further described below.

Alternatively to the magnetically-sensitive section 102 being formed using MIM, the magnetically-sensitive section 102 may be formed of other conductive material. The magnetic section 102 may be formed of a conductive metal responsive to magnetic forces, such as iron, cobalt, or nickel. The magnetically-sensitive section 102 also may be formed of a conductive plastic, such as is commonly used in potentiometers, formed of a resin and graphene or another conductive material that includes a magnetically-attractive component. The magnetically-sensitive section 102 may be formed of any conductive, magnetically-attractive material that may be fitted within the distal end 104 of the earbud 100. The magnetically-sensitive section 102 also may be formed of a material that is magnetic or that may be magnetized so as generate a magnetic force, such as how a ferrous metal may be magnetized by subjecting the ferrous metal to a magnetic field. In other words, the magnetically-attractive section 102 includes a material that has a magnetic field or is attracted to one.

The earbud 100 also may incorporate one or more magnets 108, formed of a material such as iron, neodymium, cobalt, or nickel at the distal end 104 of the earbud 100. The one or more magnets 108 may work with the magnetically-sensitive section 102 in magnetically securing the earbud 100 within a charging receptacle. In addition, if the one or more magnets 108 are conductive and electrically coupled with the magnetically-sensitive section 102, the one or more magnets 108 may add to the size of the electrode layer or plate presented by the magnetically-sensitive section 102.

The distal end 104 of the housing 106 and other portions of the housing 106 may be formed of a nonconductive material or an insulating material, such as polyurethane or another nonconductive plastic, that may be molded into a desired shape. The plastic or other nonconductive material may be used to electrically isolate the conductive, magnetically-sensitive section 102 from the ear surface 107, as well as other portions of a user's body, so that the magnetically-sensitive section 102 is not grounded to the ear surface 107 to enable the magnetic-section 102 being able to monitor capacitance of the ear surface 107.

The magnetically-sensitive section 102 is electrically coupled with OHD logic 110 by an electrical connector 112 (along with other electrical connectors described below) may include one or more wires, conductive traces, or other electrical conductors. The OHD logic 110 may be configured to monitor the distal-end capacitance detectable via the electrode presented by the magnetically-sensitive section 102. Thus, by adding the electrical connector 112 and without having to incorporate an additional electrode at the distal end 104 of the housing 106, the OHD logic 110 logic may monitor the distal-end capacitance at the distal end 104 of the housing 106.

The OHD logic 110 may be a separate device or, as shown in the example of FIG. 1, may be incorporated within control logic 114 that supports the communication functions of the earbud 100, including generating audio via a speaker 116 and/or receiving audio via a microphone 118, wirelessly communicating with a mobile telephone or other device (not shown), and to perform other functions. (The microphone 118 is shown in dotted lines in FIG. 1 because the microphone 118 may be positioned on an outside of the housing and not be positioned inside the housing 106 of the earbud 100 as in the example of FIG. 1.) The control logic 114 is electrically coupled with the speaker 116 and the microphone 118 by electrical connectors 120 and 122, respectively. The control logic 114 is also coupled with a battery 124 via an electrical connector 126 to power the functions of the earbud 100 and other various components, including the OHD logic 110.

The control logic 114 may be manipulated by a user through a touch-sensitive user input component 128 at a proximal end 130 of the earbud 100. To provide control of various functions supported by the control logic 114 of the earbud 100, the touch-sensitive user input component 128 may include multiple separate segments 132, 134, 136, 138, and 140 to receive inputs to control functions of the earbud, such as to answer or end a call, play or pause audio, increase or decrease volume, etc., depending upon which of the segments 132, 134, 136, 138, and 140 is engaged by the user. The segments 132, 134, 136, 138, and 140 are conductive and may be coupled with the control logic 114 by individual electrical connections 142.

The segments 132, 134, 136, 138, and 140 are covered by a nonconductive layer 141 to prevent electrostatic discharge between the segments 132, 134, 136, 138, and 140 and the user (not shown) to electrically isolate the touch-sensitive user input component 128. Electrically isolating the touch-sensitive user input component 128 prevents contact between the touch-sensitive user input component 128 and a body or other conductive object from electrically grounding the segments 132, 134, 136, 138, and 140 of the touch-sensitive user input component 128 to enables the touch-sensitive user input component 128 to serve as an electrode layer or plate to measure a capacitance at the proximal end 130 of the earbud 100 (a “proximal-end capacitance”). The segments 132, 134, 136, 138, and 140 also may be electrically coupled with the OHD logic 110 by an electrical connector 144 (shown in dotted lines in FIG. 1 to indicate that not all implementations of the earbud 100 may electrically couple the touch-sensitive user input component 128 with the OHD logic 110) to use one or more of the segments 132, 134, 136, 138, and 140 of the touch-sensitive user input component 128 as an electrode to monitor the proximal-end capacitance at the distal end 130 of the earbud 100. The segments 132, 134, 136, 138, and 140 may be cross-connectable by an electrical connection 144. The electrical connection 144 is shown as a dotted line in FIG. 1 to emphasize that the segments 132, 134, 136, 138, and 140 may be electrically separate to provide different inputs to the control logic 114 but may selectively cross-connectable if desired to increase the size of the electrode layer or plate formed by the segments 132, 134, 136, 138, and 140 to monitor the proximal-end capacitance at the distal end 130 of the earbud 100.

Implementations of the earbud 100 also may include an additional OHD sensor 146 electrically coupled to the OHD logic 110 by an electrical connector 148. (The additional OHD sensor 146 and the electrical connector 148 are shown in dotted lines in FIG. 1 to indicate that not all implementations of the earbud 100 may include the additional OHD sensor 146.) As described further below, the additional OHD sensor 146 may monitor an additional value indicative of whether the earbud 100 is inserted into or removed from the ear of the user. For example, the additional OHD sensor 146 may be an IR sensor that may monitor the IR energy reflection from the ear that may be detected within the ear when the earbud 100 is inserted into the ear. In the example of FIG. 1, the additional OHD sensor 146 is situated at the distal end 104 of the earbud 100, but the additional OHD sensor 146 may be located at other locations on the housing 106 where the additional OHD sensor 146 is positioned to be able to monitor the additional value.

The housing 106 may include a protrusion 150 configured to be inserted into an auditory canal 152 within the ear surface 107. The protrusion 150 includes a sound port 154 through which sound from the speaker 116 may travel into the auditory canal 152. When the earbud 100 is inserted into the ear and the protrusion 150 is inserted into the auditory canal 152, the distal end 104 of the housing 106 of the earbud 100 in proximity to the ear surface 107 and, thus, positions the magnetically-sensitive section 102 close to the ear surface 107. The proximity of the magnetically-sensitive section 102 to the ear surface 107 shortens the distance between the electrode layer or plate presented by the magnetically-sensitive section 102 and the electrode layer or plate presented by the ear surface 107 to facilitates the OHD logic 110 being able to monitor the distal-end capacitance at the distal end 104 of the housing 106.

When the proximal end 130 of the earbud 100 is in proximity to a body 156 (represented in dashed lines in FIG. 1), such as when the earbud 100 is held within a user's hand or at another location in proximity to the user's body, the OHD logic 110 may use the touch-sensitive user input component 128 to monitor the proximal-end capacitance at the proximal end 130 of the earbud 100. As described further below, when the distal-end capacitance monitored by the OHD logic 110 at the distal end 104 via the magnetically-sensitive section 102, the OHD logic 110 may initially determine that the earbud 100 is inserted within the ear. However, if the proximal-end capacitance monitored by the OHD logic 110 at the proximal end 130 via the touch-sensitive user input component 128 indicates contact with a body 156, the OHD logic 110 may be configured to recognize that the earbud 100 is held within a closed hand or a pocket, rather than being inserted with the ear. As also described further below, the OHD logic 110, in combination with measurements of the distal-end capacitance and the proximal-end capacitance, may use the additional OHD sensor 146 to make an initial determination and/or to confirm whether the earbud 100 is actually inserted within the ear.

Referring to FIG. 2, a charging case 200 includes charging receptacles 202 into which earbuds 100 may be received in order to charge the earbuds 100 from a battery or external power source (neither of which is shown in FIG. 2). The charging case may include one or more magnets 204 positioned adjacent to the charging receptacles 202 to provide magnetic attraction 206 (represented by arrows in FIG. 2) to magnetically draw or secure the earbuds 100 into the charging receptacles 202. As described with reference to FIG. 1, the distal ends 104 of the earbuds 100 include the magnetically-sensitive sections 102 which are drawn to the magnets 204 by the magnetic attraction 206. If magnetically-sensitive sections 102 are also magnetic, the magnetically-sensitive sections 102 may enhance the magnetic attraction to draw the earbuds 100 toward the magnets 204.

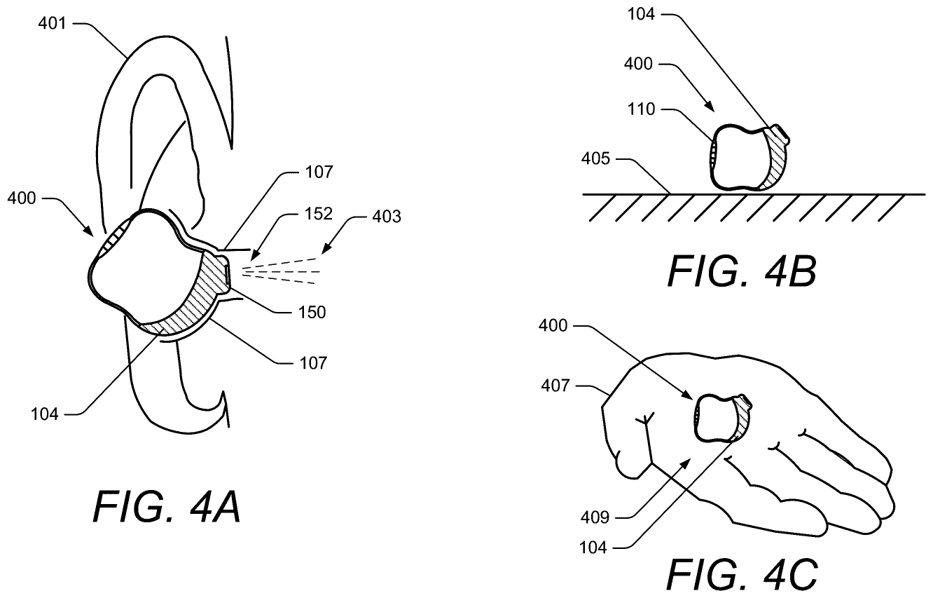

FIG. 3 shows an example implementation of the OHD logic 110 that is configured in accordance with one or more aspects to monitor a distal-end capacitance 302, a proximal-end capacitance 304, and/or an additional value 306 to determine whether the earbud 100 (not shown in FIG. 3) is inserted within an ear of the user. In various implementations, the OHD logic 110 includes capacitance-sensing circuitry 300 that is electrically coupled to the magnetically-sensitive section 102 via the electrical connector 112 and to the touch-sensitive user input component 128 via the electrical connector 144. The magnetically-sensitive section 102 and the touch-sensitive user input component 128 may each be regarded as a first electrode layer or a first plate of a respective capacitor, and the capacitive sensing circuitry 300 of the OHD logic 110 may selectively apply respective electrical signals, such as a low voltage charge, to each of the magnetically-sensitive section 102 and the touch-sensitive user input component 128. When the magnetically-sensitive section 102 or the touch-sensitive user input component 128 is in proximity to or comes into contact with the body 156, the body 156 may act as an electrode of a large capacitor coupled with ground. Thus, the body 156 may serve as a second electrode layer or a second plate of the capacitor of one of the respective capacitors. Accordingly, the contact with or proximity to the body 156 may result in a change in the voltage sensed via the magnetically-sensitive section 102 or the touch-sensitive user input component 128 when either comes in contact with or in proximity to the body 156, indicating a change in the distal-end capacitance 302 or the proximal-end capacitance 304, respectively. Thus, by monitoring changes in the electrical signals applied at the magnetically-sensitive section 102 or the touch-sensitive user input component 128, the capacitive sensing circuitry 300 of the OHD logic 110 may monitor the distal-end capacitance 302 or the proximal-end capacitance 304, respectively, to determine whether the earbud 100 is removed from the ear, as further described below with reference to FIGS. 4A-4C, 5A-5D, and 6A-6D.

The OHD logic 110 also may include additional sensing circuitry 308 coupled with the additional OHD sensor 146 via the electrical connector 148 to monitor the additional value 306. In various implementations, the additional OHD sensor 146 is configured to monitor IR energy reflection from the ear (thus the additional value 306 is depicted as energy waves in FIG. 3). When the additional value 306 includes IR energy, the additional sensing circuitry 308 may be configured, for example, to supply an electrical current to the additional OHD sensor 146 and determine a change in resistance across the additional OHD sensor 146 as a result of changes in the additional value 306. The additional OHD sensor 146 also may be configured to detect visible light (where the presence of visible light may indicate that the earbud 100 is removed from within the ear) or may monitor a different energy or other manifestation indicative of the earbud 100 being inserted within the ear.

FIGS. 4A-4C, 5A-5D, and 6A-6D depict how different implementations of the OHD logic 110 (see FIG. 1) may be configured to detect whether various implementations of an earbud 400, 500, or 600, respectively, is inserted into or is removed from within an ear 401. In the different configurations, the OHD logic 110 monitors capacitance via the magnetically-sensitive section 102 and/or the touch-sensitive user input component 128 and/or uses the additional OHD sensor 146 to monitor the additional value 306 (see FIG. 3), as described below.

FIGS. 4A-4C show an implementation of an earbud 400 configured to monitor the distal-end capacitance 302 (see FIG. 3) at the distal end 104 of the earbud 400 to determine whether the earbud 400 is inserted into the ear 401. The earbud 400 includes the magnetically-sensitive section 102 coupled with the OHD logic 110 by the connector 112 (see FIG. 1).

FIG. 4A shows the earbud 400 inserted into the ear 401 with the protrusion 150 inserted into the auditory canal 152 and with the distal end 104 of the earbud 400 (in which is positioned the magnetically-sensitive section 102, not shown in FIGS. 4A-4C) positioned against the ear surface 107. Because the distal end 104 is in contact with or in proximity to the ear surface 107, the OHD logic 110 determines that the distal-end capacitance 302 meets or exceeds a capacitance level indicative of the distal end 104 of the earbud 400 being inserted within the ear 401. In determining that the earbud 400 is inserted within the ear 401, the OHD logic 110 enables the earbud 400 (such as by issuing a signal to the control logic 114 of FIG. 1) to generate audio 403.

FIG. 4B shows the earbud 400 removed from within the ear 401 and resting on a non-capacitive surface 405, such as a tabletop or counter. Because the earbud 400 is removed from within the ear 401, the distal-end capacitance 302 is below a level that indicates that the distal end 104 of the earbud 400 is in contact with or in proximity to the ear surface 107 and, thus, is removed from within the ear 401. Accordingly, the OHD logic 110 stops the earbud 400 from generating audio.

FIG. 4C shows the earbud 400 on its side in a palm of a hand 407, which may be part of the body 156 (see FIG. 1). The distal end 104 of the earbud 400 may be in contact with or in proximity to flesh 409 of the hand 407. However, because the distal end 104 of the earbud 400 does not fully engage the flesh 409 as when the distal end 104 is in contact with or in proximity to the ear surface 107 when the earbud 400 is inserted into the ear 401, the distal-end capacitance 302 may be less than a capacitance level indicating that the earbud is inserted into the ear 401. Thus, the OHD logic 110 stops the earbud 400 from generating audio.

Depending on how the earbud 400 is grasped in the palm of the hand 407, it may be possible for the distal section 104 to be sufficiently in contact with the flesh 409 so that the distal-end capacitance 302 reaches a capacitance level that may falsely indicate that the earbud 400 is inserted within the ear 401. Accordingly, using additional indicators of whether an earbud is inserted into the ear, such as may be provided by the touch-sensitive user input component 128 monitoring the proximal-end capacitance 304 or the additional OHD sensor 146 monitoring an additional value, may enable the OHD logic 110 to more accurately determine whether an earbud 500 or 600 is inserted into the ear 401, as further described below.

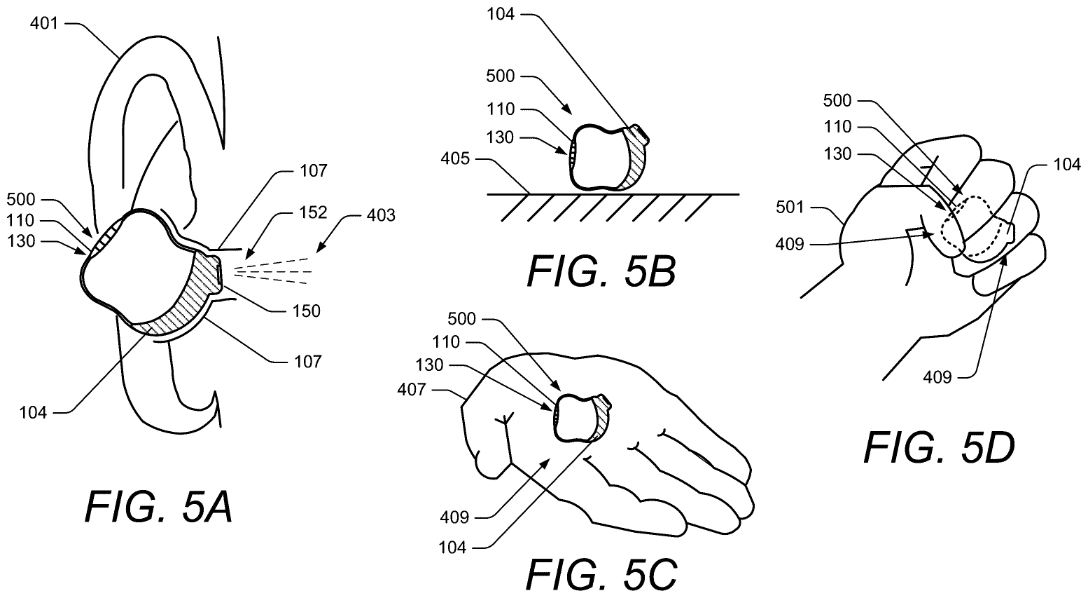

FIGS. 5A-5D show an implementation of an earbud 500 configured to monitor the distal-end capacitance 302 via the distal end 104 of the earbud 500 and the proximal-end capacitance 304 (see FIG. 3) via the touch-sensitive user input component 128 to determine whether the earbud 500 is inserted into the ear 401. The earbud 500 again includes the magnetically-sensitive section 102 within the distal end 104 coupled with the OHD logic 110 by the electrical connector 112 (see FIG. 1). The earbud 500 also uses the touch-sensitive user input component 128 coupled to the OHD logic 110 with the electrical connector 144 to monitor the proximal-end capacitance 304.

FIG. 5A shows the earbud 500 inserted into the ear 401 with the distal end 104 of the earbud 500 in contact with or in proximity to the ear surface 107. Because the distal end 104 is in contact with the ear surface 107, the OHD logic 110 monitors the distal-end capacitance 302 at a level consistent with the distal section 104 of the earbud 500 being in proximity to the ear surface 107, the OHD logic 110 determines that the distal-end capacitance 302 meets or exceeds a capacitance level indicative of the distal end 104 of the earbud 500 being inserted within the ear 401. In addition, the OHD logic 110 determines that the proximal-end capacitance 304 that is monitored by the OHD logic 110 via the touch-sensitive user input component 128 indicates that the proximal end 130 is not in contact with a body. The touch-sensitive user input component 128 is facing away from the ear 401 and, because the touch-sensitive user input component 128 is not in contact with or in proximity with the body, the proximal-end capacitance 304 is of a low level consistent with the earbud 500 being inserted within the ear 401. Thus, with the distal end 104 in contact with or in proximity to the ear surface 107 and the proximal end 130 not in contact with the body, the OHD logic 110 determines the earbud 500 is inserted within the ear 401 and enables the earbud 500 to generate audio 403.

FIG. 5B shows the earbud 500 removed from within the ear 401 and resting on the non-capacitive surface 405. Because the earbud 500 is removed from within the ear 401, the OHD logic 110 determines that the distal-end capacitance 302 is below a level that indicates that the distal end 104 of the earbud 500 is in contact with or in proximity to the ear surface 107 and, thus, is removed from within the ear 401. In various implementations, regardless of the level of the proximal-end capacitance 304 determined by the OHD logic 110, because the distal-end capacitance 302 indicates that the earbud 500 is removed from within the ear 401, the OHD logic 110 may stop the earbud 500 from generating audio.

FIG. 5C shows the earbud 500 on its side in the palm of the hand 407. The distal end 104 of the earbud 500 may be in contact with or in proximity to the flesh 409 of the hand 407. When the distal end 104 of the earbud 400 does not fully engage the flesh 409, in contrast to when the distal end 104 is in contact with or in proximity to the ear surface 107 when the earbud 400 is inserted into the ear 401, the distal-end capacitance 302 may be short of a level indicating that the earbud is inserted into the ear 401.

However, it is possible that the distal end 104 of the earbud 500 may sufficiently contact the flesh 409 to cause the distal-end capacitance 302 to reach a similar level to when the earbud 500 is inserted into the ear 401. In such a case, however, the distal end 130 also may be in contact with or in proximity to the flesh 409. As a result, the OHD logic 110 determines that the proximal-end capacitance 304 is of a level that is not consistent with the earbud 500 being inserted within the ear 401. The OHD logic 110 thus may use the proximal-end capacitance 304 to confirm whether the earbud 500 is inserted into or removed from within the ear 401 before stopping generation of audio.

In various implementations, the OHD logic 110 may be configured to determine to observe a delay interval before determining whether the proximal-end capacitance 304 registers a capacitance level consistent with contact with a body. It will be appreciated that it is undesirable for a user's engagement of the touch-sensitive user input component 128 to control functions of the earbud 500 be interpreted as the earbud 500 being removed from within the ear 401. Thus, in various implementations, the OHD logic 110 may be configured to determine that the touch-sensitive user input component 128 is in contact with a body only when the OHD logic 110 determines that the proximal-end capacitance 304 indicates that the touch-sensitive user input component 128 is in contact with a body for longer than an interval consistent with user engagement of the touch-sensitive user input component 128 to control functions of the earbud 500.

FIG. 5D shows the earbud 500 (represented in dotted lines in FIG. 5D) being held within a closed hand 501, causing both the distal end 104 and the proximal end 130 of the housing 106 of the earbud 500 to be in contact with the flesh 409 of the closed hand 501. As a result of contact with the flesh 409 of the closed hand 501, the OHD logic 110 may determine that a level of the distal-end capacitance 302 detected at the distal end 104 is consistent with the earbud 500 being inserted within the ear 401. However, the OHD logic 110 may also determine that a level of the proximal-end capacitance 304 detected at the proximal end 130 via the touch-sensitive user input component 128—particularly if the level of the proximal-end capacitance 304 is maintained for longer than a short duration consistent with a user input being made at the touch-sensitive user input component 110—is not consistent with the earbud 500 being inserted within the ear 401. Accordingly, by using the distal-end capacitance 302 monitored at the distal end 104 and the proximal-end capacitance 304 monitored at the proximal end 130, the OHD logic 110 can use multiple indicators to determine whether the earbud 500 is removed from the ear 401 and stop the generation of audio.

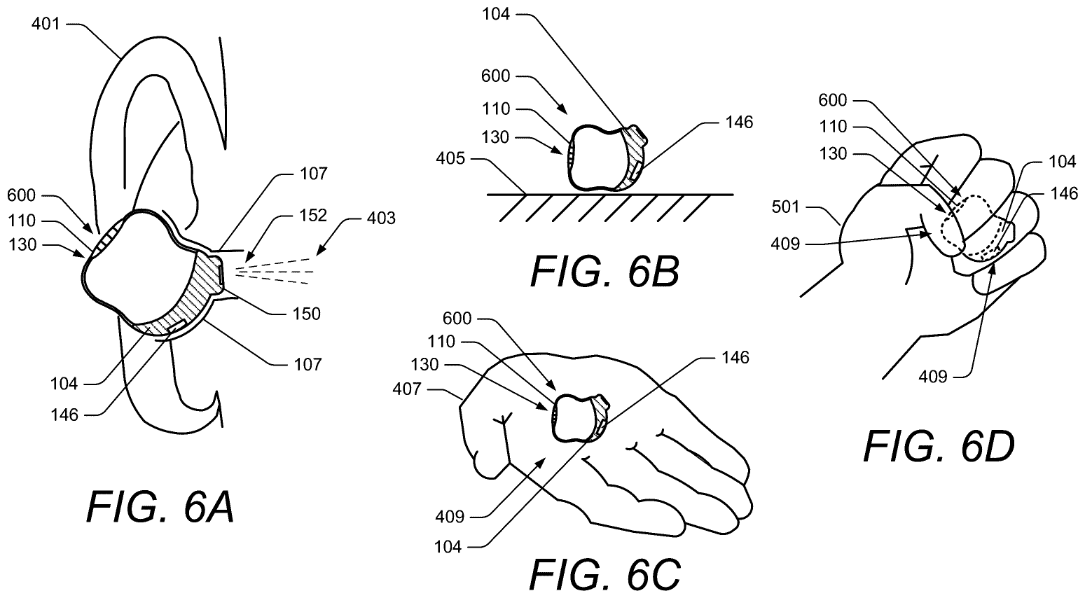

FIGS. 6A-6D show an implementation of an earbud 600 in which the OHD logic is configured to monitor the additional value 306 monitored by the additional OHD sensor 146 (see FIG. 3) in addition to the distal-end capacitance 302 monitored at the distal end 104 of the earbud 600 and the proximal-end capacitance 304 monitored at the touch-sensitive user input component 128 to determine whether the earbud 600 is inserted into the ear 401. The additional value 306 monitored by the OHD logic 110 may be used as a first indication of whether the earbud 600 is inserted within the ear 401 or may be used to confirm indications presented by the distal-end capacitance 302 and/or the proximal-end capacitance 304 as to whether the earbud is inserted within the ear 401. For purposes of the example of FIGS. 6A-6D, it is assumed that the additional OHD sensor 146 is an IR sensor, but it will be appreciated that another type of sensor that monitors a value that may indicate whether the earbud 600 is inserted into the ear 401 may also be used.

FIG. 6A shows the earbud 600 inserted into the ear 401 with the distal end 104 of the earbud 600 in proximity to the ear surface 107. Because the distal end 104 is in proximity to the ear surface 107, the OHD logic 110 monitors the distal-end capacitance 302 at a level consistent with the distal section 104 of the earbud 500 being in contact with the ear surface 107, the OHD logic 110 determines that the distal-end capacitance 302 meets or exceeds a capacitance level indicative of the distal end 104 of the earbud 500 being inserted within the ear 401. In addition, the OHD logic 110 determines that the proximal-end capacitance 304 that is monitored by the OHD logic 110 via the touch-sensitive user input component 128 indicates that the proximal end 130 is not in contact with a body. The touch-sensitive user input component 128 at the proximal end 130 is facing away from the ear 401 and, because the touch-sensitive user input component 128 is not in contact with or in proximity with the body, the proximal-end capacitance 304 is of a low level consistent with the earbud 600 being inserted within the ear 401. Thus, with the distal end 104 in contact with or in proximity to the ear surface 107 and the proximal end 130 not in contact with the body, the OHD logic 110 determines the earbud 600 is inserted within the ear 401 and enables the earbud 500 to generate audio 403.

Also, the additional OHD sensor 146 detects a level of the additional value 306, such as an IR energy level consistent with the body heat generated within the ear 401, that indicates that the earbud 600 is inserted within the ear 401. The OHD logic 110 may be configured to first monitor the additional value 306 to determine whether the earbud 600 is inserted into or removed from within the ear 401, then evaluates the distal-end capacitance 302 and/or the proximal-end capacitance 304 to confirm whether the earbud 600 is inserted into or has been removed from within the ear 401. On the other hand, the OHD logic 110 may use the distal-end capacitance 302 and/or the proximal-end capacitance 304 to determine whether the earbud 600 is inserted into or has been removed from within the ear 401 and then use the additional value 306 to confirm whether the earbud 600 is inserted into or has been removed from within the ear 401.

FIG. 6B shows the earbud 600 removed from within the ear 401 and resting on the non-capacitive surface 405. As in the example of FIG. 5B, because the earbud 600 is removed from within the ear 401, the OHD logic 110 determines that the distal-end capacitance 302 is below a level that indicates that the distal end 104 of the earbud 600 is in contact with or in proximity to the ear surface 107 and, thus, is removed from within the ear 401. In various implementations, regardless of the level of the proximal-end capacitance 304 determined by the OHD logic 110, because the distal-end capacitance 302 indicates that the earbud 600 is removed from within the ear 401, the OHD logic 110 may stop the earbud 600 from generating audio.

The additional OHD sensor 146 also may detect a level of the additional value 306, such as a low IR energy level consistent with the earbud 600 not being inserted within the ear 401. Again, the OHD logic 110 may be configured to first monitor the additional value 306 to determine whether the earbud 600 is inserted into or removed from within the ear 401 then evaluates the distal-end capacitance 302 and/or the proximal-end capacitance 304 to confirm whether the earbud 600 is inserted into or has been removed from within the ear 401. On the other hand, the OHD logic 110 may use the distal-end capacitance 302 and/or the proximal-end capacitance 304 to determine whether the earbud 600 is inserted into or has been removed from within the ear 401 and then use the additional value 306 to confirm other indicia as to whether the earbud 600 is inserted into or has been removed from within the ear 401.

It should be noted that, when the additional OHD sensor 146 includes an IR sensor, while the earbud 600 is resting on the surface 405, if the earbud 600 is exposed to sunlight or another IR energy source, the additional OHD sensor 146 may falsely determine that the additional value 306 is consistent with the earbud 600 being inserted within the ear 401. However, by monitoring indicia provided by the additional OHD sensor 146 and the distal-end capacitance 302 and/or the proximal-end capacitance 304 monitored via the distal end 104 and the touch-sensitive user input component 128, respectively, the OHD logic 110 may use multiple indicia to confirm whether the earbud 600 is removed from within the ear 401 in determining whether to stop the generation of audio.

FIG. 6C shows the earbud 600 on its side in the palm of the hand 407. The distal end 104 of the earbud 600 may engage the flesh 409 on the palm of the hand 407 and, thus, the OHD logic 110 may register some value of the distal-end capacitance 302 consistent with the distal end 104 of the earbud 600 being in contact with or in proximity to the palm of the hand 407. However, the touch-sensitive user input component 128 at the proximal end 130 may also be in contact with or in proximity to the flesh 409. As a result, the OHD logic determines that the proximal-end capacitance 304 is of a level that is not consistent with the earbud 500 being inserted within the ear 401.

Depending on how the additional OHD sensor 146 engages the flesh 409, e.g., if the additional sensor 146 rests against the flesh 409 or facing away from the flesh 409, the additional value 306 generated by the additional OHD sensor 146 may indicate that the earbud 600 is inserted into or has been removed from the ear 401, respectively. Thus, the distal-end capacitance 302 and the additional value 306 might both falsely indicate that the earbud 600 is inserted within the ear 401, but the proximal-end capacitance 304 may indicate that the earbud 600 is not inserted within the ear 401. Thus, by monitoring the distal-end capacitance 302, the proximal-end capacitance 304, and the additional value 306, the OHD logic 110 may be configured to reliably determine whether the earbud 600 is inserted within the ear 401.

FIG. 6D shows the earbud 600 (represented in dotted lines in FIG. 6D) being held within the closed hand 501, causing both the distal end 104 and the touch-sensitive user input component 128 of the earbud 500 to be in contact with the flesh 409 of the closed hand 501. As a result of contact with the flesh 409 of the closed hand 501, the OHD logic 110 may determine that a level of the distal-end capacitance 302 detected at the distal end 104 is consistent with the earbud 600 being inserted within the ear 401. Similarly, a level of the additional value 306 generated by the additional OHD sensor 146 may indicated that the earbud 600 is inserted within the ear 401, e.g., by registering an IR energy level consistent with a level of body heat expected within the ear 401 being presented within the closed had 501. Again, however, the OHD logic 110 may also determine that a level of the proximal-end capacitance 304 detected by the touch-sensitive user input component 128 at the proximal end 130 is not consistent with the earbud 600 being inserted within the ear 401. Accordingly, by monitoring the distal-end capacitance 302 monitored at the distal end 104, the proximal-end capacitance 304 monitored at the proximal end 130, and the additional value 306 monitored by the additional OHD sensor 146, the OHD logic 110 can reliably determine whether the earbud 600 is removed from the ear 401 in controlling whether audio is generated by the earbud 600.

### Example Operating Environment for Computer-Executable Instructions

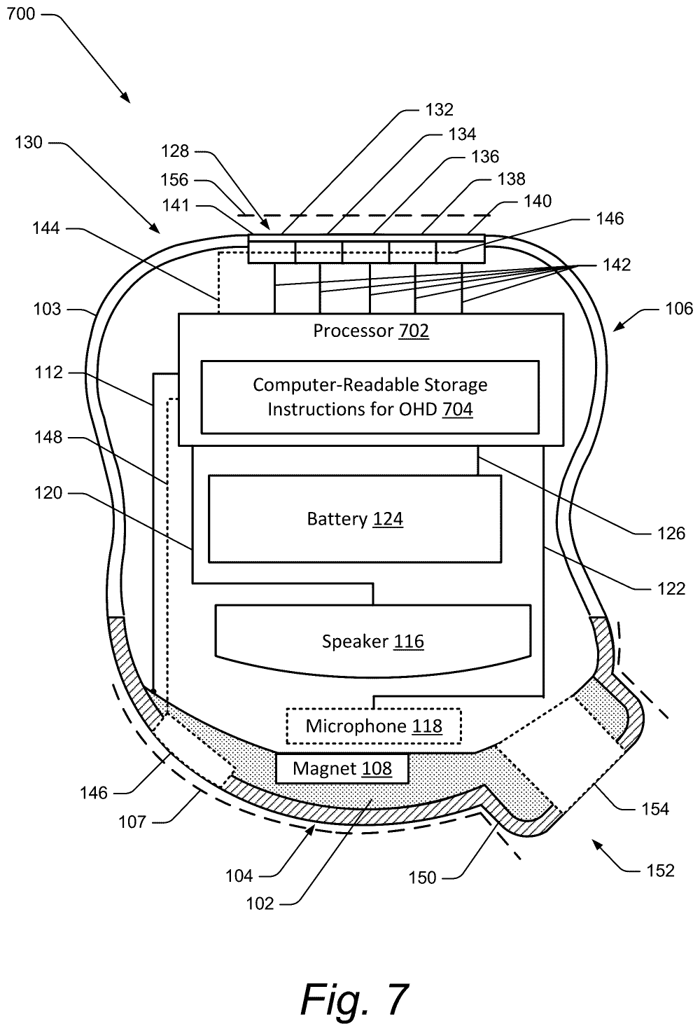

FIG. 7 shows an earbud 700 that is similar to the earbud 100 of FIG. 1 except that instead of using dedicated logic, such as the OHD logic 110 and the control logic 114, the functions of those devices are performed by a processor 702 configured to execute computer-executable instructions configured to perform OHD as previously described. The computer-executable instructions for OHD are maintained in computer-readable storage 704 accessible to the processor 702 and which may include volatile memory, such as random-access memory (“RAM”), non-volatile memory, such as read-only memory (“ROM”), flash memory, and the like, or some combination of volatile memory and non-volatile memory. The computer-executable instructions are configured to direct the processor 702 to perform the functions as previously described. The processor 702 uses the magnetically-sensitive section 102 to monitor the distal-end capacitance 302, the touch-sensitive user input component 128 to monitor the proximal-end capacitance 304, and/or the additional OHD sensor 146 to monitor an additional value, such as measured IR energy as previously described.

### Example Methods

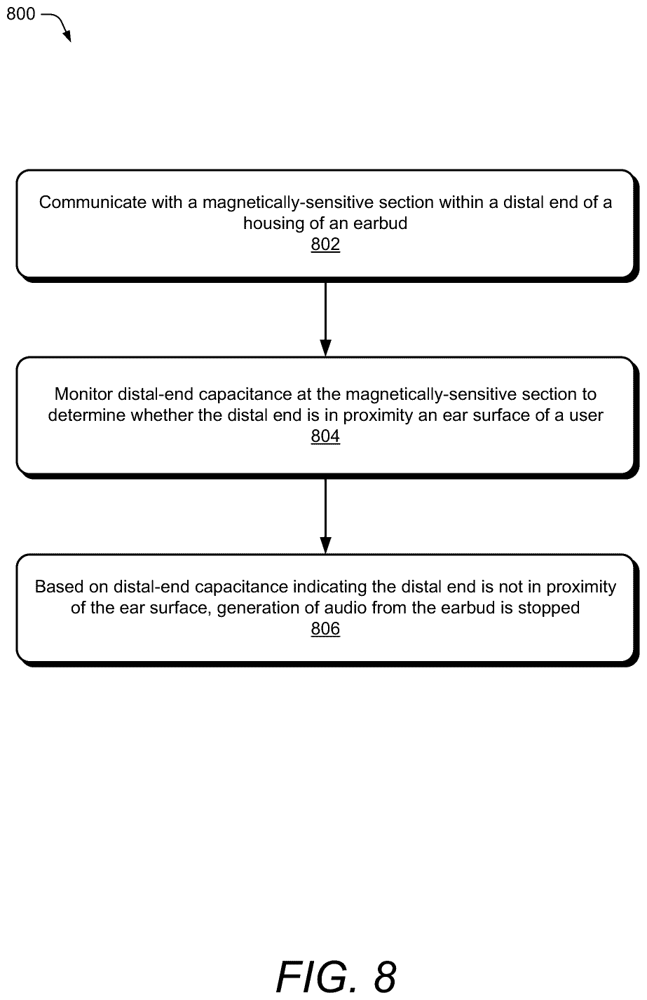

Example methods 800, 900, and 1000 are described with reference to FIGS. 8-10, respectively, to illustrate operation of the example apparatuses previously described. The methods 800, 900, and 1000 may be performed by dedicated OHD logic 110 in communication with a magnetically-sensitive section 102, a touch-sensitive user input component 110, and/or an additional OHD sensor 146, as previously described with reference to FIGS. 1-6 or by a processor 702 directed by suitable computer-executable instructions maintained in storage 704, as previously described with reference to FIG. 7.

FIG. 8 illustrates the example method 800 of controlling audio generation of an earbud based on the distal-end capacitance 302 as described with reference to FIGS. 1, 3, and 4A-4C. At a block 802, communication is established with a magnetically-sensitive section 102 within a distal end 104 of a housing 106 of an earbud 400. At a block 804, a distal-end capacitance 302 at the magnetically-sensitive section 102 is monitored to determine whether the distal end 104 is in proximity to an ear surface 107 of the ear 401 of a user (not shown). At a block 806, based on the distal-end capacitance 302 indicating that that the distal end 104 is not in proximity to the ear surface 107, generation of audio by the earbud 400 is stopped.

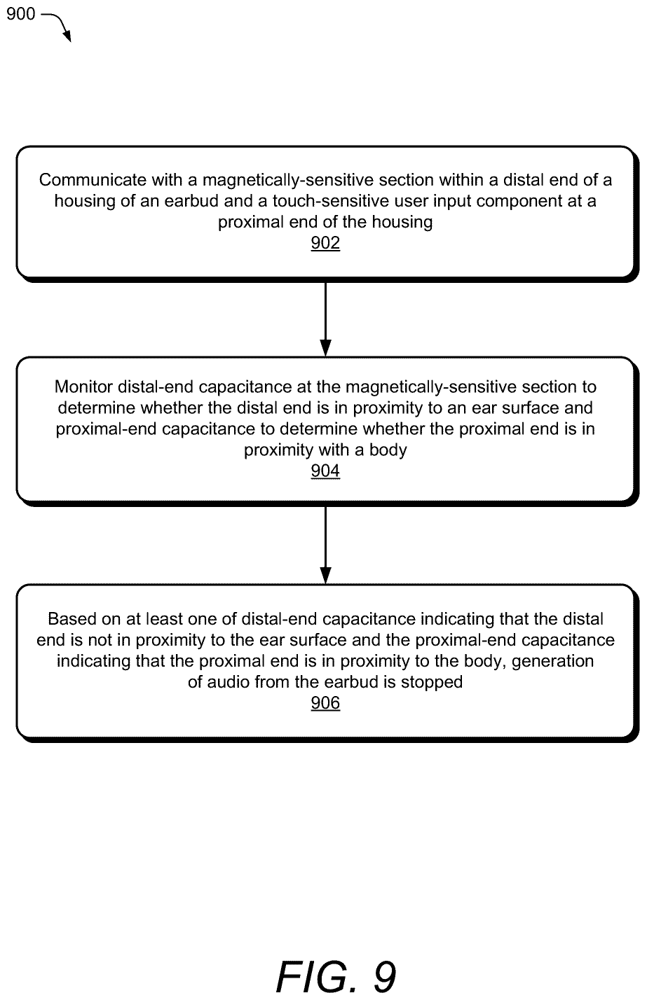

FIG. 9 illustrates the example method 900 of controlling audio generation of an earbud based on measured capacitance as described with reference to FIGS. 1, 3, and 5A-5D. At a block 902, communication is established with a magnetically-sensitive section 102 within a distal end 104 of a housing 106 of an earbud 500 and with a touch-sensitive user input component 128 at a proximal end 130 of the housing 106. At a block 904, a capacitance 302 at the magnetically-sensitive section 102 is monitored to determine whether the distal end 104 is in proximity to an ear surface 107 of the ear 401 of a user (not shown) and a proximal-end capacitance 304 is measured to determine whether the distal end 130 is in proximity with a body (e.g., the hand 407 of the user). At a block 906, based on at least one of the distal-end capacitance 302 indicating that the distal end 104 is not in proximity to the ear surface 107 and the proximal-end capacitance 304 indicating that the proximal end 130 is in proximity to the body, generation of audio by the earbud 500 is stopped.

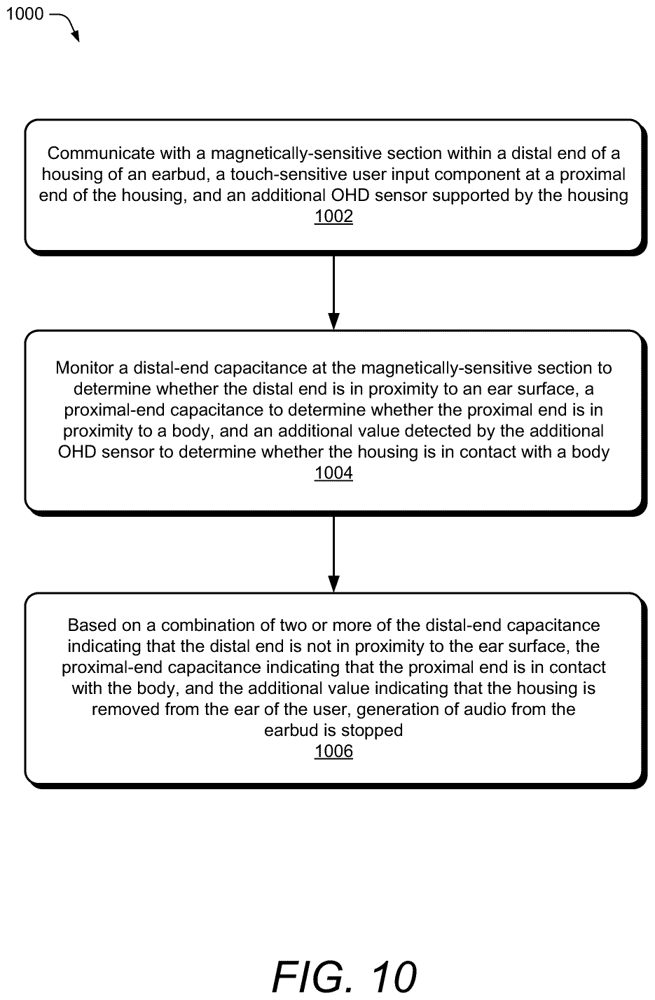

FIG. 10 illustrates the example method 1000 of controlling audio generation of an earbud based on measured capacitance as described with reference to FIGS. 1, 3, and 6A-6D. At a block 1002, communication is established with a magnetically-sensitive section 102 within a distal end 104 of a housing 106 of an earbud 600, a touch-sensitive user input component 128 at a proximal end 130 of the housing 106, and an additional OHD sensor 146 supported by the housing 106. At a block 1004, a capacitance 302 at the magnetically-sensitive section 102 is monitored to determine whether the distal end 104 is in proximity to an ear surface 107 of the ear 401 of a user (not shown), a proximal-end capacitance 304 is measured to determine whether the proximal end 130 is in proximity with a body (e.g., the hand 407 of the user), and an additional value 306 detected by the OHD sensor 146 is in proximity with a body. At a block 1006, based a combination of two or more of the distal-end capacitance 302 indicating that the distal end 104 is not in proximity to the ear surface 107, the proximal-end capacitance 304 indicating that the proximal end 130 is in proximity to the body, and the additional value 306 indicating that the housing 106 is removed from the ear 401 of the user, generation of audio by the earbud 600 is stopped. As previously described, one or more of the distal-end capacitance 302, the proximal-end capacitance 304, and the additional value 306 may be used as a first indication that the earbud 600 is removed from the ear 401, while one or more of the other values is used to confirm removal of the earbud 600 from the ear 401, as described with reference to FIGS. 6A-6D.

The preceding discussion describes systems and techniques for determining whether an earbud is removed from an ear of a user. These systems and techniques may be realized using one or more of the entities or components shown in FIGS. 1-7 or the methods of FIGS. 8-10, which may be further divided, combined, and so on. Thus, these figures illustrate some of the many possible systems capable of employing the described techniques.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### ADDITIONAL EXAMPLES

In the following section, additional examples are provided.

Example 1: An earbud comprising: a housing having a distal end and a proximal end, the distal end including a magnetically-sensitive section, the distal end of the housing configured to be: magnetically attracted to a charging receptacle, and insertable within an ear of a user; and on-head-detection (OHD) logic electrically coupled to the magnetically-sensitive section at the distal end, the OHD logic configured to determine, based on a distal-end capacitance measured using the magnetically-sensitive section, whether the distal end of the housing is within the ear of the user.

Example 2: The earbud of example 1, wherein the magnetically-sensitive section includes a metal injection molding (MIM) section including metal powder mixed with a binding material.

Example 3: The earbud of example 1, wherein the magnetically-sensitive section is formed to substantially span the distal end of the housing.

Example 4: The earbud of claim 1, further comprising a touch-sensitive user input component disposed at the proximal end of the earbud housing and electrically coupled with the OHD logic, the touch-sensitive user input component configured to operate control logic of the earbud and be usable by the OHD logic to determine whether a proximal-end capacitance at the proximal end of the housing indicates whether the proximal end of the housing is in proximity to a body indicating that the earbud is removed from within the ear of the user.

Example 5: The earbud of example 4, wherein the touch-sensitive user input component includes multiple segments configured to receive separate user inputs to the control logic of the earbud and the OHD logic is further configured to electrically combine the multiple segments for operation as the second electrode.

Example 6: The earbud of example 4, wherein the OHD logic is further configured to determine that the earbud is removed from within the ear of the user based on distal-end capacitance and the proximal-end capacitance indicating that the earbud is removed from within the ear of the user.

Example 7: The earbud of example 6, wherein the OHD logic is further configured to first determine that the earbud is removed from within the ear of the user based on distal-end capacitance and then confirm that the earbud is removed from within the ear of the user based on the proximal-end capacitance.

Example 8: The earbud of example 6, wherein the OHD logic is further configured to first determine that the earbud is removed from within the ear of the user based on the proximal-end capacitance and then confirm that the earbud is removed from within the ear of the user based on distal-end capacitance.

Example 9: The earbud of examples 1 or 4, further comprising an additional OHD sensor disposed in the housing and coupled with the OHD logic, wherein the OHD logic measures an additional value detectable by the additional OHD sensor that is indicative of whether the earbud is removed from within the ear of the user.

Example 10: The earbud of example 9, wherein the additional OHD sensor includes an infrared (IR) sensor and the additional value includes an IR energy level detected by the IR sensor.

Example 11: The earbud of example 9, wherein based on the OHD logic determining that the additional value indicates that the earbud is removed from within the ear of the user, determining whether the distal-end capacitance indicates that the earbud is removed from within the ear of the user.

Example 12: The earbud of example 9, wherein based on the OHD logic determining that the distal-end capacitance indicates that the earbud is removed from within the ear of the user, the OHD logic is further configured to determine whether the additional value indicates whether the earbud is removed from within the ear of the user.

Example 13: The earbud of examples 1-12, wherein the earbud further includes a speaker and wherein the OHD logic is further configured to stop the speaker from generating audio based on the OHD logic determining that the earbud is removed from within the ear of the user.

Example 14: A method of determining whether the earbud is removed from within the ear of the user using the earbud of any one of examples 1-13.

Example 15: A computer-readable storage medium comprising instructions that, when executed by one or more processors, cause the one or more processors to execute the method of example 14.

### CONCLUSION

Although implementations for determining whether an earbud is removed from within an ear of a user by measuring capacitance using a magnetically-sensitive section and/or a touch-sensitive user input component and optionally using an additional OHD sensor to measure an additional value indicative of whether the earbud has been removed from within the ear of the user, have been described in language specific to certain features and/or methods, the subject of the appended claims is not necessarily limited to the specific features or methods described. Rather, the specific features and methods are disclosed as example implementations for determining whether an earbud is removed from within an ear of a user by monitoring capacitance using the magnetically-sensitive section and/or the touch-sensitive user input component and/or monitoring an additional value detected by the additional OHD sensor.

What is claimed is:

1. An earbud comprising:
a housing having a distal end and a proximal end,
the distal end including a magnetically-sensitive section, the distal end of the housing configured to be:
magnetically attracted to a charging receptacle, and
insertable within an ear of a user, and
on-head-detection (OHD) logic electrically coupled to the magnetically-sensitive section at the distal end, the OHD logic configured to determine, based on a distal-end capacitance measured using the magnetically-sensitive section, whether the distal end of the housing is within the ear of the user.

2. The earbud of claim 1, wherein the magnetically-sensitive section includes a metal injection molding (MIM) section including metal powder mixed with a binding material.

3. The earbud of claim 1, wherein the magnetically-sensitive section is formed to substantially span the distal end of the housing.

4. The earbud of claim 1, further comprising a touch-sensitive user input component disposed at the proximal end of the earbud housing and electrically coupled with the OHD logic, the touch-sensitive user input component configured to operate control logic of the earbud and be usable by the OHD logic to determine whether a proximal-end capacitance at the proximal end of the housing indicates whether the proximal end of the housing is in proximity to a body indicating that the earbud is not inserted within the ear of the user.

5. The earbud of claim 4, wherein the touch-sensitive user input component includes multiple segments configured to receive separate user inputs to the control logic of the earbud and the OHD logic is further configured to electrically combine the multiple segments for operation as an electrode.

6. The earbud of claim 4, wherein the OHD logic is further configured to determine that the earbud is not inserted within the ear of the user based on distal-end capacitance and the proximal-end capacitance.

7. The earbud of claim 6, wherein the OHD logic is further configured to first determine that the earbud is removed from within the ear of the user based on the distal-end capacitance and then confirm that the earbud is removed from within the ear of the user based on the proximal-end capacitance.

8. The earbud of claim 6, wherein the OHD logic is further configured to first determine that the earbud is removed from within the ear of the user based on the proximal-end capacitance and then confirm that the earbud is removed from within the ear of the user based on distal-end capacitance.

9. The earbud of claim 1, further comprising an OHD sensor disposed in the housing and coupled with the OHD logic, wherein the OHD logic monitors a value detectable by the OHD sensor that is indicative of whether the earbud is within the ear of the user.

10. The earbud of claim 9, wherein the OHD sensor includes an infrared (IR) sensor and the value includes an IR energy level detected by the IR sensor.

11. The earbud of claim 1, wherein the earbud further includes a speaker and wherein the OHD logic is further configured to stop the speaker from generating audio based on the OHD logic determining that the earbud is removed from within the ear of the user.

12. A method comprising:
monitoring a distal-end capacitance at a magnetically-sensitive section within a distal end of a housing of an earbud; and
responsive to the distal-end capacitance indicating that the distal end of the housing of the earbud is not in proximity to an ear surface, ceasing generation of audio from the earbud.

13. The method of claim 12, further comprising determining that the distal-end capacitance indicates that the distal end of the housing of the earbud is not in proximity to the ear surface.

14. The method of claim 12, further comprising:
monitoring proximal-end capacitance of the housing of the earbud;
determining that the proximal-end capacitance of the housing of the earbud indicates that the proximal end is in proximity with a body, and
wherein ceasing the generation of the audio from the earbud is further responsive to determining that the proximal-end capacitance of the housing of the earbud indicates that the proximal end is in proximity with the body.

15. The method of claim 14, further comprising:
monitoring a value detected by a sensor supported by the housing of the earbud;
determining that the value indicates that the housing is in contact with the body, and
wherein ceasing the generation of the audio from the earbud is further responsive to determining that the value indicates that the housing is in contact with the body.

16. The method of claim 14, wherein monitoring the proximal-end capacitance of the housing of the earbud monitors a touch-sensitive user input component at the proximal-end of the housing of the earbud.

17. The method of claim 12, further comprising:
monitoring a value detected by a sensor supported by the housing of the earbud;
determining that the value indicates that the housing is in contact with the body, and
wherein ceasing the generation of the audio from the earbud is further responsive to determining that the value indicates that the housing is in contact with the body.

18. The method of claim 17, wherein monitoring the value detected by the sensor supported by the housing of the earbud monitors an infrared (IR) sensor configured to detect IR energy emitted by the IR proximity sensor ceasing to be reflected by the ear surface.

19. A computer-readable storage medium comprising instructions that, when executed by one or more processors, cause the one or more processors to perform operations comprising:
monitoring a distal-end capacitance at a magnetically-sensitive section within a distal end of a housing of an earbud; and
responsive to the distal-end capacitance indicating that the distal end of the housing of the earbud is not in proximity to an ear surface, ceasing generation of audio from the earbud.

20. The computer-readable storage medium of claim 19, wherein the instructions cause the one or more processors to perform operations further comprising:
monitoring proximal-end capacitance of the housing of the earbud;
determining that the proximal-end capacitance of the housing of the earbud indicates that the proximal end is in proximity with a body, and
wherein ceasing the generation of the audio from the earbud is further responsive to determining that the proximal-end capacitance of the housing of the earbud indicates that the proximal end is in proximity with the body.
